(19) United States
(12) Patent Application Publication
(10) Pub. No.: US 2022/0364411 A1
(43) Pub. Date: Nov. 17, 2022

(54) Preliminary Products for Light Protection Devices with High-Precision Optics for Glare-Free Light Deflection

(71) Applicant: Helmut KOESTER, Frankfurt (DE)

(72) Inventor: Helmut Koester, Frankfurt (DE)

(21) Appl. No.: 17/609,248

(22) PCT Filed: May 5, 2020
(86) PCT No.: PCT/EP2020/062474

§ 371 Date: May 8, 2022

(30) Foreign Application Priority Data
May 6, 2019 (DE) 10 2019 206 496.5
Aug. 30, 2019 (DE) 10 2019 006 130.6

(51) Int. Cl. E06B 9/386; F21S 11/00

(52) U.S. Cl. CPC E06B 9/386; F21S 11/007; E06B 2009/2417

(57) ABSTRACT

The invention relates to a planar preliminary product for producing focusing light-directing slats having a top side and an underside. The top side and the underside are the largest sides in terms of area. The top side has a groove structure having parallel grooves and ridges in a longitudinal direction and having a multiplicity of sidewalls F₁ and F₂. A respective pair of sidewalls F₁ and F₂ forms a common ridge projecting on the top side. The sidewalls F₁ and F₂ are in each case at an angle with respect to one another which is at least approximately constant along the transverse direction and longitudinal direction of the groove structure. The top side has an overall contour defined by the vertices of the ridges. The sidewalls F₁ and F₂ of adjacent pairs are at an angle γ with respect to one another. The sidewalls F₁ and F₂ are symmetrical with respect to one another in relation to an area of symmetry, which is oriented at right angles with respect to the overall contour and is arranged at the location lying in the centre between the sidewalls F₁ and F₂. The angle γ between all pairs of sidewalls F₁ and F₂ is at least approximately constant. The sidewalls have a surface, which surfaces specularly reflect light substantially according to the law of reflection that angle of incidence is equal to angle of reflection.

### FIELD OF THE INVENTION

The invention relates to a planar preliminary product for producing focusing light directing slats having a top side and an underside. The top side and the underside are the largest sides in terms of area. The top side has a groove structure having parallel grooves and ridges in a longitudinal direction and having a multiplicity of sidewalls F₁ and F₂. A respective pair of sidewalls F₁ and F₂ forms a common ridge projecting on the top side. The sidewalls F₁ and F₂ are in each case at an angle with respect to one another which is at least approximately constant along the transverse direction and longitudinal direction of the groove structure. The top side has an overall contour defined by the vertices of the ridges. The sidewalls F₁ and F₂ of adjacent pairs are at an angle γ with respect to one another.

### BACKGROUND OF THE INVENTION

DE 10 2014 005 480 presents a preliminary product of a prism embossing structure on a flat, rolled strip, which is brought to its final, focusing contour in a second work step by means of slat curving. A disadvantage of this structure is that each individual mirror prism has a different contour and in addition, for each slat width, a dedicated surface has to be developed, for which each mirror prism has to be shaped differently.

EP 1212 508 B1 discloses in FIG. 9 microprism structures on light-directing slats. The description explains the method for applying and curing sol-gel coatings with a prismatic shaping.

The disadvantage of the methods explained therein is the inorganic sol-gel coating and the sawtooth-like prism contour. The individual mirror prisms have very different contours. This requires extremely complex tool geometries in order to form Fresnel optics. In FIG. 9, each microprism has a different shape. If the slat width changes, then the slat curvature and the prism shaping automatically change, with the result that a dedicated tool is required for each slat width. In addition, the explained methods for producing prisms with sol-gel have proved not to be successful. Hitherto it has not been technically possible to reproduce the contour illustrated in FIG. 9 on a slat using a sol-gel, nor has sufficient adhesion been achieved in respect of the UV-curing sol-gel coatings adhering to the metallic slats, nor has it been possible to achieve sufficient precision and sharpness of edges of the prism vertices by means of the UV-curing, nor have the slats been able to be coiled after application of the sol-gel layer without producing microfractures in the glass-hard coating. Infiltrations take place through the microfractures in the glass-hard sol-gel layers and result in detachments. The sol-gel coating has to be admixed with solvents in order to lower its viscosity and make it processible. This needs to be avoided in order also to prevent so-called fogging, which, in the case of use in insulating glass, initiates colour shifts in the case of precipitation on the glass pane.

DE 10 2013 019 295 A1 explains a focusing mirror prism configuration. However, it lacks any teaching of how the skilled worker has to curve the slats in relation to the slat width and in relation to the inclination of the prism sidewalls. It lacks any rule for determining the distance between the slats. Moreover, it is not known how the flat, prism-structured strip should be manifested as a preliminary product for a focusing slat in the curved end product.

FIGS. 4 and 7 show slats having sawtooth-like structures in aluminium, which, in order to be able to be embossed, require a large material thickness and in addition can only be produced from very soft, embossable ultra-pure aluminium material. The disadvantage of these slats is the high material consumption and the deficient elasticity of the soft aluminium material, warping the slats. Embodying the prism vertices with sharp edges and without glare fails to be achieved here as well. The aluminium does not flow right into the tool vertices during embossing. An identifying feature of all types of slats in DE 10 2013 019 295 A1 is the asymmetrical sawtooth formations. Adjacent mirror prisms are asymmetrical with respect to one another. The angles of the groove valleys vary and are not constant in their magnitude over the slat cross section. A bending radius for the preliminary product of the slats is not specified. A tangent angle to the concave/convex curving contour of the slats is not specified. The contours do not follow a circular contour. In particular, there is no indication of the surface contour of a flat, embossed strip material as a preliminary product for concave/convex slat production. These features and defects also apply to all of the further figures.

Furthermore, it holds true that the construction method with reference to FIG. 7 does not result in the desired focusing in FIG. 4 since, in the case of the angles Rn a correction factor has to be introduced since the distance between the reflector fragments and the focus changes when the parabola fragment is transferred to the slat contour. Even for a person skilled in the art it is not possible to develop, from the description in terms of the objective for forming the angles βn, a flat preliminary material which enables a specific focusing after a curvature process.

All slats—whether produced by an extrusion method, by a rolling method or by a roll forming method—are distinguished by roundings with non-targeted light scatterings at the prism vertices, which do not make it possible to produce precision optics to allow all rays incident on the slats to be directed in or out as desired. A high precision of the light guidance is necessary, however, in order that the slats are free of glare and optimizable in terms of their light and energy distribution. In the case of prism structures in the micro range, edge roundings give rise to holographic and colour effects, which should be avoided owing to the requirement for sharp edges.

Whatever known production method is chosen for the known light-directing slats, it disadvantageously requires, for each slat width and/or a changed slat distance, a dedicated geometry and a dedicated tool for prism shaping.

### OBJECTS AND SUMMARY OF THE INVENTION

The object of the invention is to reproduce a three-dimensional mirror structure for focusing light reflection on a flat material and furthermore to develop a production method that makes it possible to produce the slat preliminary material, including the micromirror structure, with large working widths. Said material is intended subsequently to be split into any desired slat widths and, without specific adaptation of the geometry of the microstructure to specific slat widths, curvatures and slat distances, nevertheless to achieve the desired focusing light-directing behaviour of blind hangings.

With the three-dimensional configuration of the slat top sides, the invention has furthermore set itself the object of developing a teaching for calculating and producing a variety of blind and/or slat widths. It is furthermore an aim to make available to the skilled worker for further processing a construction teaching for determining the slat distance and the slat width, the radius of curvature and the slat tilt angles and, by means of these measurable variables, for nevertheless accurately positioning the non-measurable angles of the sunlit micromirror sidewalls.

The objects are achieved in accordance with the characterizing part of the main claim and of the production claims.

The fold structure should be understood to mean individual triangles which form fine grooves parallel to the slat contours and which are reflectively coated on the top side. The innovation provides for impressing and/or imprinting a fold structure. σₚ is the angle of the sunlit fold sidewalls with respect to the slat base in the preliminary product in the planar state before curvature. σₚ is the angle of the sunlit fold sidewalls with respect to the horizontal, this angle varying on account of the later slat curvatures over the entire cross section.

The planar preliminary product is characterized in that an undistorted mirror image is recognizable without focusing properties. The end products are characterized by a focusing of the reflections even without producing an exact Fresnel mirror, and nevertheless fulfilling all objectives of glare-free light guidance. The overall contour is characterized by a connecting line through the vertices, i.e. through the highest elevations of the ridges. Those sections of the ridges which project the furthest from the top side form vertex lines.

The innovation is based on the teaching of how, totally independently of the desired slat widths of various types of blinds, it is possible to develop an optical system which always develops identical optical effects despite variable slat widths, with the result that there is the possibility of splitting off any desired slat widths from a mother coil having a multiplicity of identical mirror folds, and of using said slat widths for blinds having various slat widths, slat curvatures and slat distances.

In contrast to the known law that optical structures can be arbitrarily increased in size or decreased in size, the teaching of the invention relates to a constant-size three-dimensional mirror optical system of a preliminary material, wherein in the end product despite proportional increase and decrease of the slat widths b and/or their distances D among one another and their radii r and/or the curvatures identical light reflection effects are achievable by virtue of the angles γ between the grooves matching the desired contour. The central concept of the innovation is to develop in the preliminary product a three-dimensional geometry whose sole variable in the end product is the angle γ in order to obtain from the flat preliminary material a focusing end shaping of a slat of any desired width, without the need to adapt the sidewalls F₁ and F₂ of the individual mirror prisms. The idea is to be able to use just a single surface having identical prisms for all blind variants and/or slat widths.

The way in which this object is achieved is shown in FIG. 2 and FIG. 3:

The angle σₚ of the catheti in FIGS. 3 and 4 is identical despite different slat curvatures and slat distances, even though the distance a₁ and a₂ between a curve point and the slat edge and the distance D₁ and D₂ between the slats and also the radii r₁ and r₂ of the slat contours can be very different. The ratio of h/B and D/B remains constant, however. Only the angle γ changes in the slat contours. The angles σ₁ in the slat edges and the slat centre in FIG. 3 are identical to σ₂ in FIG. 4. All other sidewall angles σ deviate from one another.

It is exactly this surprising insight of the geometry that is used by the innovation in the three-dimensional configuration of the mirror contour in the preliminary product in order to simplify the tools for contour shaping, the production methods, and also the logistics and stock-keeping of preliminary material by comparison with DE 10 2014 005 480. The innovative teaching of producing the correct mirror contour only by means of the angle adaptation γ by introducing an overall contour affords the possibility of producing prism films having a multiplicity of identical mirror foldings with any desired working widths, of separating them into any desired strip widths and of applying them to any desired slat widths in order ultimately to produce totally different hangings having slat widths of e.g. 12 mm to 100 mm width with different curvatures and nevertheless to achieve identical optical and energetic properties for all the different hangings. It is possible to produce composites of microstructured films on slat bodies with very large, economic working widths, to metallize them over the full working width and to laminate them onto a strip material before or after splitting in order to achieve the desired focusing properties in a final work step by means of a concave/convex curvature of the slats.

The focusing overall structure itself is shaped into the narrow slats, as usual, by means of roller set pairs. It is only by means of the specific contour curvature of the slats rather than, as in the prior art, by means of the configuration of the individual prisms and/or by means of specific slat tilt angles, that the individual slats having identical mirror folds acquire the actual reflection optical system for the desired focusing guidance of the reflected rays, e.g. in the manner of or similar to a Fresnel optical system. It has been necessary hitherto to calculate or to adapt the exact prism contour anew depending on the slat width and/or the slat tilt angles. As a result of the curvature, only the angles γ between the mirror grooves change in the innovation. This is easily possible because the prisms are printed onto a very thin, flexible film.

The innovation provides (FIGS. 3 and 4) for producing by means of identical, symmetrical, grooved triangles only by way of the slat curvature a structure similar to a fragmented parabola from sunlit sidewall Fi to sunlit sidewall Fi, which as a result, in the case of lateral light incidence, reflects the latter back in the direction of the light incidence, wherein at least individual reflected beam paths cross one another and form a focusing zone in the direction of the light incidence.

In contrast to the prior art in PCT/EPOO/05929 or U.S. Pat. No. 10,107,031 B2 or DE 102013019295 A1 with sawtooth-like asymmetrical teeth, the grooved triangles themselves, preferably also the overall contour, are embodied symmetrically, with the result that a slat, independently of the orientation with respect to the light incidence, e.g. in the case of rotation about a vertical axis, has an identical optical reflection behaviour (see FIGS. 8 and 9). The symmetry is an essential aspect of the teaching because, when the slats are assembled to form a hanging, for example, errors cannot occur if the slats are placed into the ladder cords in a mirror-inverted manner. This aspect is of great importance in practice because the microstructures are not discernible to the unaided eye and are inferred from customary production control during construction of blinds. In order to realize this objective, the slat contour having specularly reflective triangles is defined for a horizontal working position of the slats, also in order to ensure an optimum view between the slats and in order to minimize solar altitude tracking of the slat tilt angles that is otherwise required.

Not only the triangles themselves are symmetrical; two adjacent triangles are also symmetrical with respect to one another (FIGS. 2.1, 2.2). As a result of the later contouring of the slats, the triangle angles and symmetry are maintained; essentially only the angle γ between adjacent triangles changes. The latter become smaller as a result of the concave shaping. In the case of microsized triangles, the angle changes between adjacent prisms are only fractions of angles γ. The wider the slats and the smaller the microstructure, the smaller the angle changes γ. The teaching of the invention is—in contrast to the prior art—not to vary the triangles themselves, but rather only the angles between the triangles in adaptation to the curvature in a downstream production method. However, the sidewalls can also warp in the course of the concave-convex shaping. This is unimportant, however, because this has a negligibly small effect on the optical system.

A particularly advantageous optical system results—as illustrated in FIG. 7—if the curve tangents tin the case of a horizontal slat position for an angle of 15°±3°, preferably 15°, with respect to the horizontal H and the triangle sidewalls are preferably embodied at the angle σₚ=45° with respect to the base and the triangle vertices are embodied as 90°. The slat distance preferably results from a shadow line at an angle αₛ of approximately 30°. If these ratios of D/B are chosen to be 0.50±0.05, it can be ensured that the reflection back of the retroreflections from the glazing in the case of a horizontal slat position is substantially directed at the underside of the upper slat, without being perceived as glare in the pane by the user of the interior.

The sidewalls F₁ and F₂ of the mirror triangles are preferably embodied with angles of inclination with respect to the base of σₚ=45°±3, without the innovation being restricted to these angle indications (FIG. 1). The triangle sidewalls F have e.g. a minimum width of the order of magnitude of 1-30 μm. The slats themselves preferably have a concave top side contour. Since it is not possible to measure the minimum angle changes in a microstructure, the innovation provides for defining the angle changes γ by way of the slat contour, in particular by way of the tangent inclination angles of the slats at the slat edges and also the circle sector angles β and the radius r—that is to say by way of measurement values that are easily checkable during manufacture.

The glare suppression function is discussed in EP 1212 508 B1 and in PCT/EP 0005929, but with no explanation of what angles σₚ are established by the designer for the prism sidewalls F₁ and F₂ with respect to the base in the flat preliminary material, in particular how they should be determined for different slat widths, specifically in the case of a horizontal slat position (best view!). Moreover, it is necessary to adhere to the principle of monoreflectivity. “Monoreflectivity” means that the reflection back into the exterior area A takes place as much as possible without oscillating reflection between the slats.

The inventiveness resides in a simple preliminary product that is suitable for all blind slat widths, and in the simplified design rules and production methods in conjunction with simultaneously complying with the complex requirements in respect of freedom from glare in exterior glazing and the reflection optics for monoreflective light deflection in the case of horizontal slat positioning.

There are two possibilities for producing the microstructure: either a printing varnish is transferred to a carrier film as a triangular groove structure by means of an intaglio printing cylinder and is anchored on the film or a high-pressure roller is used to carry out embossing into a liquid varnish. Both of the methods require UV curing.

Polymerizing printing varnishes are applied in liquid form and cure in fractions of seconds under UV light or electron irradiation to form hard and durable surfaces and can economically reproduce 3D structures with layer thicknesses of even <5 μm. Preferably, a polymerizing printing varnish is applied to a transparent, UV-transmissive film, wherein the UV curing takes place by means of UV irradiation according to the invention via the rear side of the film. The technical challenge consists in forming the individual triangle vertices with sharp edges, wherein 100% of the varnish or structure/contour must be delivered to the flat film in order that 100% of the contour of the intaglio printing cylinder is reproduced and the vertices of the triangles are formed exactly. The challenge associated with the requirement for sharp edges is the 100% release of varnish from the intaglio printing cylinder, which is realized by virtue of the fact that the curing takes place exclusively by means of UV radiation from below through a transparent film, without the structure roller itself being impinged on by irradiation or without the varnish already being cured on the roller. The method is free of fogging because no solvents are required. This is a major aspect of the innovative production technology.

This method has never before been used for producing microsized mirror prisms, particularly not for the production of light protection devices such as curved slats of blinds. The subsequent reflective coating of the innovative microstructure in a vapour deposition/sputtering process has also not been known hitherto. It has been customary practice hitherto to carry out vapour deposition on the smooth underside and to carry out embossing into the flat film on the front side (nanoprint method). However, this produces prism effects, i.e. light refraction effects in optically denser media, which are unwanted in the present case. On account of edge roundings in an embossed film, the light is partly dispersed into its spectral colours, which produces coloured and holographic effects, which need to be avoided in the present case.

A further development provides for applying a thermoplastic or heat-reactivatable coating online on the rear side of the film, said coating serving to combine the film with the slat body between heatable rollers by means of a fusion process. What are suitable for this are e.g. PVC or acrylic varnishes or readily fusible films as interlayer. The teaching of the innovation provides for obtaining the specific, focusing optical system downstream by means of the slat curvature.

The prisms themselves can be applied to very thin films <30 μm or even 6 to 12 μm, e.g. composed of PET or PMMA, Triton, PVC or PC, with an anchoring printing varnish, or e.g. on a thicker transfer carrier film with transferable printing varnish. After prism transfer, the transfer carrier film is removed and reused. All these methods allow the production of high-precision micro- or even nanostructures which guarantee extraordinarily accurate light deflection, are applied in a very thin fashion and are less fragile and also very economical in terms of material consumption in comparison with sol-gel coatings.

### BRIEF DESCRIPTION OF THE DRAWINGS

Further explanations will be given on the basis of the descriptions of the figures, in which:

FIG. 1 shows the cross section through a slat having identical, symmetrical prisms before the concave/convex shaping,

FIGS. 2.1 and 2.2 show the contour configuration before and after slat shaping,

FIGS. 3 and 4 show a pair of slats of a blind hanging with exemplary light guidance,

FIG. 5 shows the geometric principles of slat shaping,

FIG. 6 shows the determination of the tangent inclination and of the radii for slat shaping,

FIG. 7 shows the determination of the slat contour in relation to the slat distance.

FIGS. 8, 9 show the reflection behaviour of a circularly curved light-directing slat in the case of light incidence at the angle of the shadow line.

FIGS. 10, 11 show the ray tracing on slat segments.

FIG. 12 shows the mirror behaviour of reflected radiation at glazing.

FIG. 13 shows ray tracing between the sidewalls F₁ and F₂.

### DETAILED DESCRIPTION OF THE INVENTION

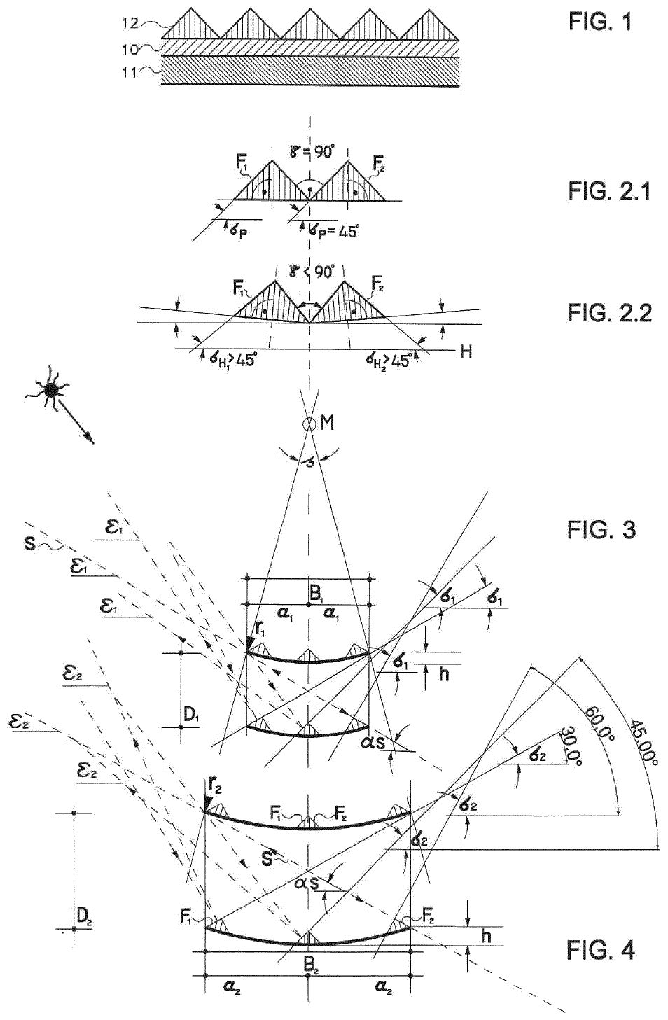

FIG. 1 shows a preliminary product in cross section, consisting of a main body 11 and the triangular grooves 12. The grooves 12 are situated on or in a carrier film 10 combined with the slat body 11. The grooved furrows are either imprinted or embossed and reflectively coated/metallized in the preliminary product. The term preliminary product relates to a web-type material with any desired working width. The preliminary product can be split into narrow strips. The end product of a focusing slat arises as a result of curvature of the split-off preliminary product. The individual work steps are preferably carried out from the coil.

In the case of a film support, the bond between slats 11 and carrier film 10 is effected by adhesive bonding, preferably by means of hot melt adhesives in a continuous method between two heated rollers. The continuous method works from coil to coil. The main body 11 consists e.g. of aluminium or steel or else of plastic or wood veneer and can also be brought to a concave/convex shape already prior to roller feed-in or the slats are shaped after the splitting of a wide strip.

FIG. 2.1 shows the triangular, symmetrical shaping and arrangement of the grooves. In the preliminary product, all adjacent triangles are at the same angle with respect to one another, an angle γ of 90° resulting by way of example in FIG. 2.1. The focusing optical system in the end product is produced by means of a reduction of the angle γ, as illustrated in FIG. 2.2. This is achieved by means of a concave curvature of the slat base. The curvature results in angles σ_{H} with respect to the horizontal at the prism sidewalls located towards the incidence of radiation.

In FIG. 3, σ_{H} increases from the irradiation side towards the interior. In the slat centre, σ_{H}≅σₚ; at the slat edge located towards the interior, σ_{H}>σₚ results in an optimized manner. In accordance with the teaching of the innovation, the focusing optical system is the result of the subsequent slat curvature. Slat width, slat distance and the focusing properties are defined exclusively by way of the angle γ between the triangles and are checked e.g. by way of the tangents t of the slat contour.

The cathetus or prism sidewalls F are of an economic order of magnitude of between 1 μm and 60 μm, preferably 2-3 μm, thus resulting in an overall construction of the lamination film of just 10 to 50 μm. If the groove structure is embossed into a film, similar dimensions result. However, other dimensions and film thicknesses are possible. An ideal optical system can be realized in the case of an inclination of the triangle sidewalls of σp=45° with respect to the base.

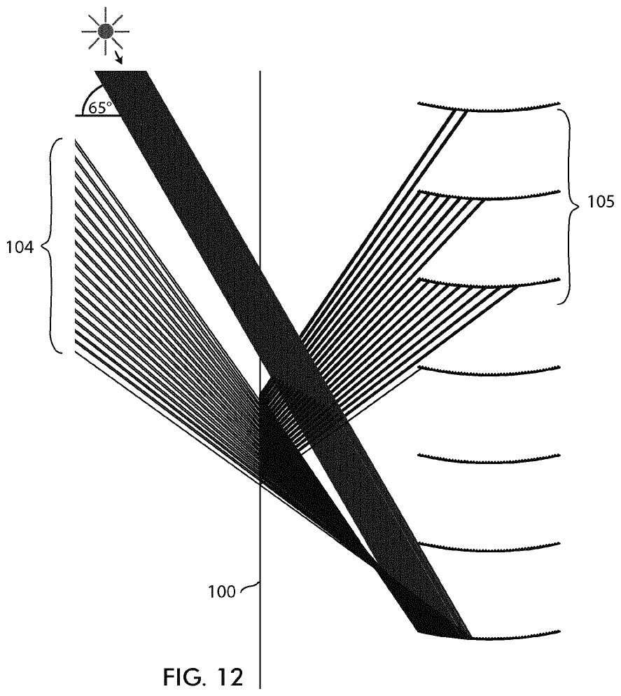

FIGS. 3 and 4 show pairs of slats with lateral incidence of solar radiation and the reflections thereof. In the present case, the angle αₛ corresponds to the inclination of the shadow line S of an upper slat edge in relation to the inner edge of a lower slat. Since a ray reflected in the direction of the light incidence does not undershoot the angle αₛ, there is also no occurrence of glare on account of specular reflection in an exterior pane. This type of glare suppression is realized by the triangle contour and also the slat contour because individual specular reflections between the slats are prevented from reaching the observer's eye. In this respect, see also FIG. 11.

It is evident that the slat bodies differ considerably in their width B₁ versus B₂ and in their distance D₁ versus D₂ and in their radius r and in their curvature. Nevertheless, according to the invention, with a single groove contour, the shape and size of the individual triangles of which do not differ, it is possible to achieve an identical light guidance of reflected light rays provided that the ratio h/B and/or D/B is maintained. This is the case if the sidewalls F₁ are at identical angles σ=σ′ with respect to the horizontal at least at the edges and in the slat centre.

For identical angles of incidence of solar radiation, the same angles ε₁=ε₂ of reflective rays result e.g. at the slat edges and in the slat centre in both of FIGS. 3 and 4. In order to realize this, the following rule or design methodology holds true for the slat contour:

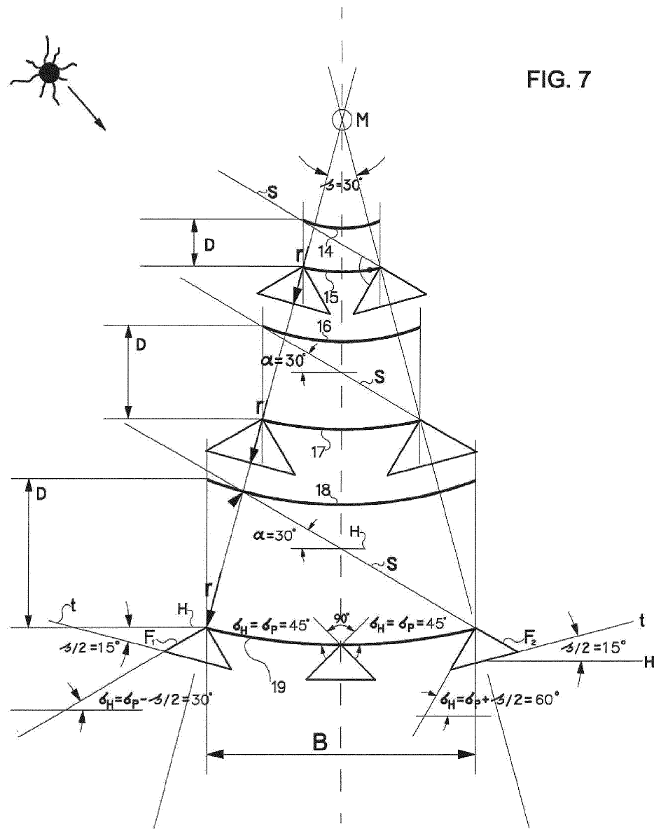

In FIG. 7, a circle sector is formed at the angle β and the slat width b is thereby determined, such that for σₚ for the slat contour a tangent angle β/2 arises in the slat edges. The radius r and/or the slat widths can then be chosen to be of any desired magnitude. Prisms where σₚ=45° are depicted in each case, wherein the base of the curve tangent t is positioned at the angle β/2. Independently of the slat width B, the same optical relationships are always ensured. The slat distances D among one another change proportionally to the slat width and are preferably determined by the angle αₛ of the shadow line S in order that the specular reflection of the retroreflection in an exterior pane cannot penetrate between the slats into the interior (see also FIG. 12). The prism sidewall exposed to the incidence of radiation at the slat edge on the interior side is ideally formed at a right angle with respect to the shadow line S, as a result of which the inclination angle αₛ=30° of the shadow line S is also determined. The angle σ_{H} of the prism sidewalls at the slat edge oriented towards the interior I thus results as σ_{H}=σₚ+β/2=60° for β=30°, and the angles of the slat tangents tin the edges result as β/2.

An optimum slat distance D results as D=B×tan αₛ.

The segment height h likewise varies proportionally to the slat width and is determined as h=B/2×tan (β/4).

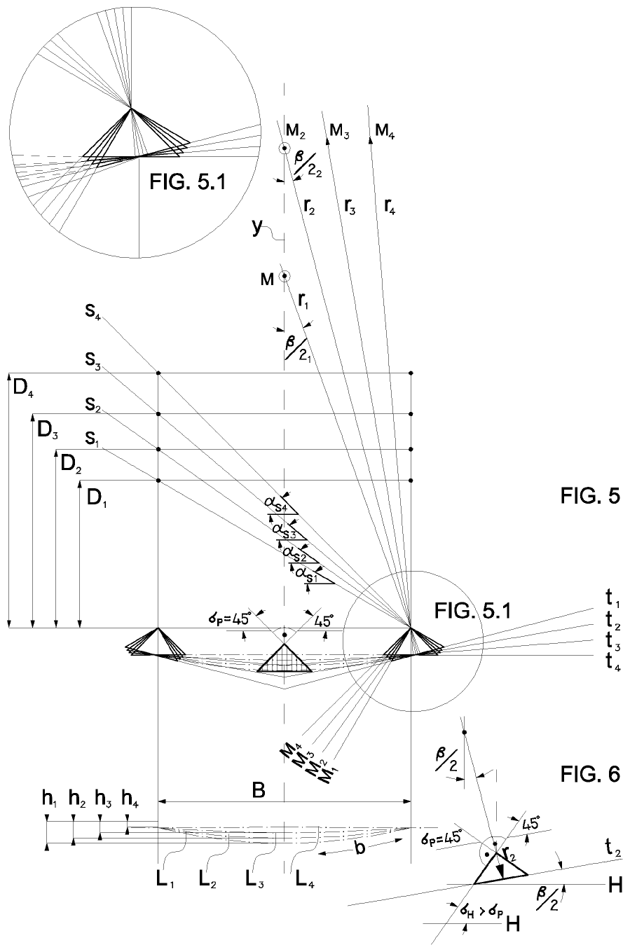

The slat cut width b (FIG. 5) is determined as b=β/360°×2r×π.

If a slat width B is predefined, then the radius r of the slat contour is determined as r=B/2×sin (β/2).

The advantage of the innovation is that the constructor of blinds, using these simple dimensions, can carry out quality control, despite the triangle mirrors on the top side contour not being discernible to said constructor on account of the microstructure.

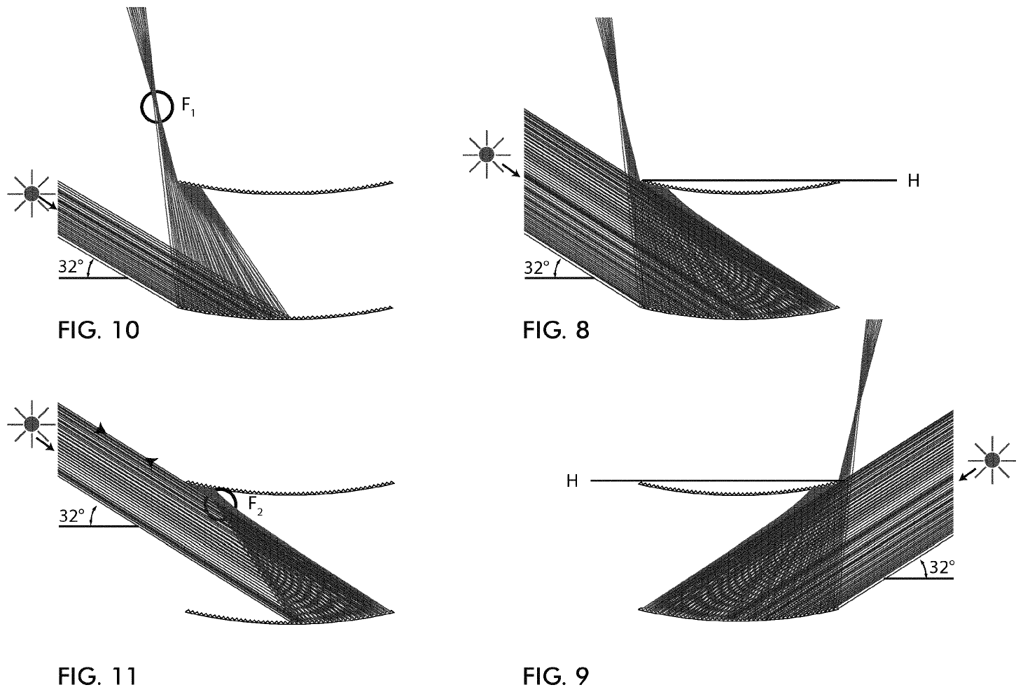

Deviations from ideal dimensions determined computationally should be afforded tolerance in a manner governed by manufacturing. A slat in the shape of an arc of a circle with mirror symmetry of the prisms by way of the slat centre enables a very good approximation to a Fresnel focusing optical system as shown in FIGS. 8 to 11.

The prisms are illustrated in a manner enlarged by a multiple in all the drawings. Nano- or microsizes of the prism sidewalls are involved in reality. The latter form mini fragments of curve progressions and make it possible, depending on shaping or curve progression of the slat body, to precisely reproduce any desired geometry by adaptation of the angles γ. The prism sidewalls irradiated by the sun complement one another as a result of the slat shaping in their minimum size to form a continuous mirror optical system by virtue of the matching of the angles γ between the prisms e.g. as a result of a minimum angle reduction from a desired focusing optical system.

The following applies to the innovative microstructures: the smaller the prisms are chosen to be, the more accurately the desired focusing effect is realized by means of the slat contour. Therefore, the size and sharp-edged embodiment of the prisms with sidewalls <60 μm, advantageously <5 μm, are of elementary importance for a precision of the light guidance.

The prism films are metallized with aluminium, for example, in a high vacuum. Colour designs are possible by means of metallic additives or else vapour depositions of gold or silver or later transparent, thin colour varnishes.

Since there is the occurrence of specular reflections in the exterior glazing in the event of reflections back into the fagade, said specular reflections, as already described, being trapped on the underside of the slats, it is possible also to reflectively coat the slat undersides and/or to equip them with mirror prism supports which reflect the impinging specular reflection back into the exterior glazing. At least bright coatings, e.g. white, are recommendable.

FIG. 5 elucidates the geometric interactions in the curvature of the basic contour. The figure shows the logic of the prism configuration as a consequence of the radii r. In the present case, the design is once again based on a mirror prism where σₚ=45° and the contour configuration of the concave slat curvature is elucidated on the basis of four different radii r with circle centres M₁ to M₄.

Depending on the magnitude of the radii r, the result is different inclination angles σ_{H} of the prisms in adaptation to the tangent inclination angles t₁ to t₄ in the slat edges. The prism sidewalls are indicatively assigned to M₁ to M₄. Upon complying with the requirement for freedom from glare owing to specular reflection of the reflection in an exterior glazing, the shadow line S₁ to S₄ is arranged at right angles with respect to the sunlit sidewall F₁ of the prism at the slat edge towards the interior (enlarged view in FIG. 5.1), thus giving rise to the angles αₛ₁ to αₛ₄ of the shadow lines depending on the slat radius r and the position of the centres M₁ to M₄ on an axis γ of symmetry.

The exact curvature of the slats L₁ to L₄ varies with the centres M₁, to M₄ and is discernible in the basis contour b. The resulting segment heights h₁ to h₄ of the slats are all the smaller, the larger the radius r formed. At the same time, the smaller the radius r, the shallower the resulting angles αₛ₁ to αₛ₄ of the shadow lines S₁ to S₄ and the smaller the slat distance D₁ to D₄, too. The variations of the slat widths b are negligible in the case of microprisms.

FIG. 6 shows a greatly enlarged view of a triangular prism at the slat edge towards the interior from FIG. 5 and FIG. 5.1, the base of which prism, following the slat contour, is arranged at an angle β/2. Since the prism angles σₚ and σ_{H} are not verifiable on account of the minimal size, the prism angles σ_{H} are determined by the angle of the tangent t with respect to the horizontal H e.g. with β/2, wherein β corresponds to the centre angle at M.

If the slats are formed symmetrically about a central axis γ, the prism inclination angles likewise turn out to be mirror-symmetrical. By virtue of the angle indication of the slat contour at the end points, the microstructure is also able to be controlled by a constructor of blinds easily with a template, for example, whereby a major objective of the innovation is fulfilled. All the triangular prisms are embodied at the angle of σₚ=45° in FIGS. 5 and 6. This is not a condition, however. Optimal results are also achievable with angles σₚ of 30° to 50°. σₚ<45° results in larger slat distances D. σₚ>45° results in smaller slat distances D.

In order to realize an optimum reflection optical system of a concave/convex light-deflecting slat taking account of freedom from glare in the exterior glazing in the event of the blinds being mounted behind glass in the interior, the following dependencies exist: For a ratio of

Slat distance D to slat width B

D/B=0.58±0.05

the prism angle is σₚ>30°<50°, preferably σₚ=45°.

The tangents tin the edges of the slat bodies are inclined 15°±5° with respect to the horizontal under the above conditions in the case of a horizontal slat position.

This results in a rise h of the curved slat body as a ratio to the slat width B

h/B>0.07<0.13, preferably h/B 0.1±0.01.

In order to shape the slat body correctly, an optimum ratio of the radius r to the slat width B of

r/B<2.5>1.5, preferably r/B=1.94±0.1

is defined.

The following holds true as a guideline value for the slat contour: the larger the distance D as a ratio to the slat width B is chosen and the larger the angle αₛ of the shadow line S is chosen, the shallower the prism angle σₚ and/or σ_{H} that can be determined at the slat edge located towards the interior. For a ratio D/B˜0.58 and a shadow line of 30°, the prism angle in the region of the slat edge on the irradiation side is σ=30° in order largely to avoid glare in the event of reflection back into the glazing.

FIG. 8 shows a radiation analysis of an end product curved in an arc of a circle from a flat preliminary product for an angle of incidence of solar radiation at the angle of the shadow line of 32°, specifically for a folding at the angle σₚ=45°. FIG. 9 shows the light incidence at the angle of 32° from the opposite direction with an identical reflection behaviour. The advantage of the development is the symmetry of the structure, which precludes wrong incorporation of the slats in a hanging.

FIG. 10 shows an analysis of the ray tracing in the first slat segment, and FIG. 11 shows that in the second slat segment. By means of the circular rounding-off, only a concentration zone can be formed, but not an exact focus, wherein the first slat segment forms a focus zone F₁, and the second segment a focus zone F₂. The illustration does not show the second reflection at the slat underside, through which the radiation is reflected back into the exterior area.

What is crucial is that no glare occurs in the exterior glazing. This is precluded because a ray incident at the smaller angle <αₛ of the shadow line is reflected more steeply than the shadow line to the underside of the upper slat.

FIG. 12 shows the specular reflection in the exterior pane 100 for incidence of solar radiation of 65°. No ray 104 reflected back towards the outside can produce glare upon specular reflection at the exterior pane 100 between the slats in the interior since all rays 105 are trapped on the slat undersides. This is the realization of an innovation goal of the preliminary product and of the teaching for determining the curved basic contour and also for determining the correct slat distance D as a ratio to the slat width B.

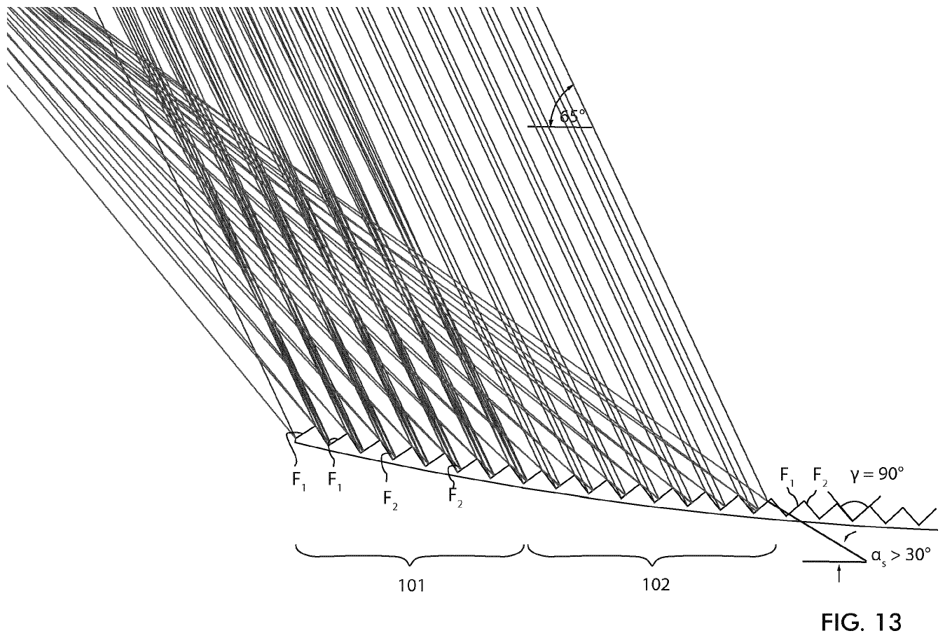

FIG. 13 shows an enlarged view of the mirror structure and of the reflection behaviour in the case of incidence of solar radiation of 65°. The largest portion of radiation impinges on the sidewalls F₁. A small part of the radiation impinges on the sidewall F₂ and is deflected to the sidewall F₁. In the first segment 101 it is shown that the radiation is reflected back from F₁ in the direction of the incidence of solar radiation. Therefore, even a secondary reflection cannot initiate glare owing to an unavoidable specular reflection in the exterior pane.

The reason for this ray guidance is the merely minimal deviation γ from the right angle between F₁ and F₂. The advantage of the microstructures according to the invention is that the angle deviations, as explained with reference to FIGS. 2.1 and 2.2, turn out to be all the more minimal, the smaller the structures. An angle deviation of less than 1/1000th° is ultimately involved—that is to say an optically negligible order of magnitude.

In contrast to the prior art in accordance with DE 10 2014 005 480, the innovative preliminary product has achieved a significant technical advance as a result of a simplification of the microstructure, which nevertheless enables all differentiated requirements in respect of directing light and freedom from glare.

The following paragraphs list certain embodiments of the invention.

Paragraph 1

Planar preliminary product for producing focusing light-directing slats having a top side and an underside, wherein the top side and the underside are the largest sides in terms of area, wherein at least the top side has a groove structure having parallel grooves and ridges in a longitudinal direction and having a multiplicity of sidewalls F₁ and F₂, wherein a respective pair of sidewalls F₁ and F₂ forms a common ridge sidewalls projecting on the top side,

wherein the F₁ and F₂ are in each case at an angle with respect to one another which is at least approximately constant along the transverse direction and longitudinal direction of the groove structure, and wherein the top side has an overall contour defined by the vertices of the ridges,

wherein the sidewalls F₁ and F₂ of adjacent pairs are at an angle γ with respect to one another,

characterized in that

the sidewalls F₁ and F₂ are symmetrical with respect to one another in relation to an area of symmetry which is oriented at right angles with respect to the overall contour and is arranged at the location lying in the centre between the sidewalls F₁ and F₂, wherein the angle γ between all pairs of sidewalls F₁ and F₂ is at least approximately constant,

wherein the sidewalls each have a surface, which surfaces specularly reflect light substantially according to the law of reflection that angle of incidence is equal to angle of reflection.

Paragraph 2

Strip-shaped preliminary product for producing focusing light-directing slats according to paragraph 1, characterized in that the sidewalls F₁ and F₂ are embodied as smaller than 1/10 mm.

Paragraph 3

Strip-shaped preliminary product for producing focusing light-directing slats according to either of the preceding paragraphs, characterized in that the angle γ between all pairs of sidewalls F₁ and F₂ is greater than or equal to 70° and less than 110°, preferably 90°.

Paragraph 4

Strip-shaped preliminary product for producing focusing light-directing slats according to any of the preceding paragraphs, characterized in that the sidewalls F₁ and F₂ of two adjacent pairs are symmetrical with respect to one another in relation to an area of symmetry which is oriented at right angles with respect to the overall contour and is arranged at the location lying in the centre between the pairs.

Paragraph 5

Light-directing slat having a top side and an underside, wherein the top side and the underside are the largest sides in terms of area, wherein the top side has a groove structure having parallel grooves and ridges in a longitudinal direction and having a multiplicity of sidewalls F₁ and F₂, wherein a respective pair of sidewalls F₁ and F₂ forms a common ridge projecting on the top side,

wherein the sidewalls F₁ and F₂ are in each case at an angle with respect to one another which is at least approximately constant along the transverse direction and longitudinal direction of the groove structure, and

wherein the top side has an overall contour defined by the vertices of the ridges, wherein the sidewalls F₁ and F₂ of adjacent pairs are at an angle γ with respect to one another,

characterized in that

the sidewalls F₁ and F₂ are symmetrical with respect to one another in relation to an area of symmetry which is oriented at right angles with respect to an overall contour and is arranged at the location lying in the centre between the sidewalls F₁ and F₂, wherein the angle γ between all pairs of sidewalls F₁ and F₂ is at least approximately constant, and

wherein the sidewalls have a surface, which surfaces specularly reflect light substantially according to the law of reflection that angle of incidence is equal to angle of reflection, wherein the light-directing slat has a first and a second slat longitudinal edge, and wherein the light-directing slat in particular is taken from a planar preliminary product according to claim 1 and/or is separated from a strip-shaped preliminary product according to any of claims 1 to 4 transversely with respect to the longitudinal direction of the groove structure.

Paragraph 6

Light-directing slat according to paragraph 5, characterized in that the angle σ_{H1} of the sidewall F₁ in relation to a connecting line from the first slat longitudinal edge to the second slat longitudinal edge increases continuously over the width of the light-directing slat from the first slat longitudinal edge to the second slat longitudinal edge, wherein in particular an angle σ_{H2} of the sidewall F₂ in relation to the connecting line increases continuously over the width from the second slat longitudinal edge to the first slat longitudinal edge of the light-directing slat, and wherein the light-directing slat is curved concavely at its top side and the underside is curved convexly.

Paragraph 7

Light-directing slat according to either of paragraphs 5 and 6, characterized in that the overall contour is at least approximately in the shape of an arc of a circle.

Paragraph 8

Light-directing slat according to paragraph 7, wherein the overall contour has the shape of a circle sector having a circle sector angle β,

characterized in that the angles of the tangents t to the overall contour at both slat longitudinal edges relative to a connecting line from a first slat longitudinal edge to a second slat longitudinal edge are at least approximately equal in magnitude, wherein the angles of the tangents t are in each case approximately equal to half the angle of the circle sector angle β, wherein half the angle of the circle sector angle β is preferably greater than 5° and less than 20° and particularly preferably between 12° and 18°, in particular 14°-16°.

Paragraph 9

Light-directing slat according to any of paragraphs 5 to 8, characterized in that the sidewalls F₁ and F₂ of the legs of an isosceles triangle approximately form a right angle between the legs, wherein a sidewall F₁ at the first slat longitudinal edge and a sidewall F₂ at the second slat longitudinal edge in each case form an angle with respect to a connecting line in the transverse direction of the light-directing slat between the first and second slat longitudinal edges of 20° to 42°, preferably between 28° and 32°, wherein the tangents to the overall contour at the slat longitudinal edges are approximately half the circle sector angle β.

Paragraph 10

Sun protection device, characterized in that the sun protection device comprises at least one upper and one lower light-directing slat according to one or more of paragraphs 5-9, wherein during operation with a maximum horizontal view between the light-directing slats in particular a shadow line of a slat longitudinal edge of an upper light-directing slat extends to a slat longitudinal edge of a lower light-directing slat on the shadow side, wherein the shadow line is at an angle αₛ with respect to the horizontal, wherein the angle αₛ is at least approximately equal to the circle sector angle β, wherein the vertical distance D between the undersides of the upper and lower light-directing slats is equal to the width β multiplied by the tangent of the angle αₛ.

Paragraph 11

Sun protection device according to paragraph 10, characterized in that a radius r of curvature of the overall contour of the light-directing slat transversely with respect to the longitudinal direction is at least approximately equal to the width b of the light-directing slat divided by double the sine of half the circle sector angle β, preferably a ratio B/r being 0.5±0.05, with preference 0.51.

Paragraph 12

Sun protection device according to paragraph 10 or 11, characterized in that a preliminary material width β of a preliminary product of a light-directing slat that is curved transversely with respect to the longitudinal direction is equal to the radius r of curvature multiplied by the circle sector angle β in radians, with preference a ratio r/b being greater than 1.5 and less than 2.5, particularly preferably 1.9±0.2.

Paragraph 13

Method for producing a light-directing slat according to at least one of paragraphs 5 to 9, wherein a preliminary product according to any of claims 1 to 5 is used, characterized in that the preliminary product is reshaped into a light-directing slat that is concave at the top side, wherein the angle γ is reduced by the reshaping process.

Paragraph 14

Method according to paragraph 13, characterized

in that a planar preliminary product is embodied as wider on a strip-shaped preliminary product for slat production,

wherein the width of the strip-shaped preliminary material is defined transversely with respect to the longitudinal direction of the groove structure,

and the strip-shaped preliminary product with a width β of a light-directing slat is split from the starting material.

Paragraph 15

Method for producing a preliminary product according to any of paragraphs 1 to 4 or a light directing slat according to any of claims 5 to 9, characterized in that the preliminary product or the light-directing slat is produced by its being provided with the groove structure by

a) the groove structure being embossed into the preliminary product or the light-directing slat and subsequently being reflectively coated, in particular metallized, or

b) a transparent lamination film structured with the sidewalls F₁ and F₂ being applied to a carrier material,

wherein the sidewalls F₁ and F₂ are applied to the lamination film by a printing method, in particular in a rotary printing method,

wherein in particular a polymerizing printing varnish is applied,

wherein either the structure is deposited from a structured roller onto the film, or the structure is embossed into an applied printing varnish,

wherein the structured printing varnish is preferably cured, in particular by means of UV radiation, wherein the UV radiation impinges on the printing varnish preferably from the rear side through the film and cures said printing varnish, wherein afterwards the lamination film is metallized on the printed side.

1. Planar preliminary product for producing focusing light-directing slats having a top side and an underside, comprising a top side and an underside are the largest sides in terms of area, wherein at least the top side has a groove structure having parallel grooves and ridges in a longitudinal direction and having a multiplicity of sidewalls F₁ and F₂, wherein a respective pair of sidewalls F₁ and F₂ forms a common ridge sidewall projecting on the top side,
wherein the sidewalls F₁ and F₂ are in each case at an angle with respect to one another which is at least approximately constant along the transverse direction and longitudinal direction of the groove structure, and wherein the top side has an overall contour defined by the vertices of the ridges,
wherein the sidewalls F₁ and F₂ of adjacent pairs are at an angle γ with respect to one another,
characterized in that
the sidewalls F₁ and F₂ are symmetrical with respect to one another in relation to an area of symmetry which is oriented at right angles with respect to the overall contour and is arranged at the location lying in the centre between the sidewalls F₁ and F₂, wherein the angle γ between all pairs of sidewalls F₁ and F₂ is at least approximately constant,
wherein the sidewalls each have a surface, which surfaces specularly reflect light substantially according to the law of reflection that angle of incidence is equal to angle of reflection.

2. Strip-shaped preliminary product for producing focusing light-directing slats according to claim 1, characterized in that the sidewalls F₁ and F₂ are embodied as smaller than 1/10 mm.

3. Strip-shaped preliminary product for producing focusing light-directing slats according to claim 1, characterized in that the angle γ between all pairs of sidewalls F₁ and F₂ is greater than or equal to 70° and less than 1 10°, preferably 90°.

4. Strip-shaped preliminary product for producing focusing light-directing slats according to claim 1, characterized in that the sidewalls F₁ and F₂ of two adjacent pairs are symmetrical with respect to one another in relation to an area of symmetry which is oriented at right angles with respect to the overall contour and is arranged at the location lying in the centre between the pairs.

5. Light-directing slat comprising a top side and an underside, wherein the top side and the underside are the largest sides in terms of area, wherein the top side has a groove structure having parallel grooves and ridges in a longitudinal direction and having a multiplicity of sidewalls F₁ and F₂, wherein a respective pair of sidewalls F₁ and F₂ forms a common ridge projecting on the top side,
wherein the sidewalls F₁ and F₂ are in each case at an angle with respect to one another which is at least approximately constant along the transverse direction and longitudinal direction of the groove structure, and
wherein the top side has an overall contour defined by the vertices of the ridges, wherein the sidewalls F₁ and F₂ of adjacent pairs are at an angle γ with respect to one another,
characterized in that
the sidewalls F₁ and F₂ are symmetrical with respect to one another in relation to an area of symmetry which is oriented at right angles with respect to an overall contour and is arranged at the location lying in the centre between the sidewalls F₁ and F₂, wherein the angle γ between all pairs of sidewalls F₁ and F₂ is at least approximately constant, and
wherein the sidewalls have a surface, which surfaces specularly reflect light substantially according to the law of reflection that angle of incidence is equal to angle of reflection, wherein the light-directing slat has a first and a second slat longitudinal edge, and wherein the light-directing slat in particular is taken from a planar preliminary product according to claim 1 transversely with respect to the longitudinal direction of the groove structure.

6. Light-directing slat according to claim 5, characterized in that the angle σ_{H1} of the sidewall F₁ in relation to a connecting line from the first slat longitudinal edge to the second slat longitudinal edge increases continuously over the width of the light-directing slat from the first slat longitudinal edge to the second slat longitudinal edge, wherein in particular an angle σ_{H2} of the sidewall F₂ in relation to the connecting line increases continuously over the width from the second slat longitudinal edge to the first slat longitudinal edge of the light-directing slat, and wherein the light-directing slat is curved concavely at its top side and the underside is curved convexly.

7. Light-directing slat according to claim 5, characterized in that the overall contour is at least approximately in the shape of an arc of a circle.

8. Light-directing slat according to claim 7, wherein the overall contour has the shape of a circle sector having a circle sector angle β,
characterized in that the angles of the tangents t to the overall contour at both slat longitudinal edges relative to a connecting line from a first slat longitudinal edge to a second slat longitudinal edge are at least approximately equal in magnitude, wherein the angles of the tangents t are in each case approximately equal to half the angle of the circle sector angle β, wherein half the angle of the circle sector angle β is preferably greater than 5° and less than 20° and particularly preferably between 12° and 18°, in particular 14°-16°.

9. Light-directing slat according to claim 5, characterized in that the sidewalls F₁ and F₂ of the legs of an isosceles triangle approximately form a right angle between the legs, wherein a sidewall F₁ at the first slat longitudinal edge and a sidewall F₂ at the second slat longitudinal edge in each case form an angle with respect to a connecting line in the transverse direction of the light-directing slat between the first and second slat longitudinal edges of 20° to 42°, preferably between 28° and 32°, wherein the tangents to the overall contour at the slat longitudinal edges are approximately half the circle sector angle β.

10. Sun protection device, characterized in that the sun protection device comprises at least one upper and one lower light-directing slat according to claim 5, wherein during operation with a maximum horizontal view between the light-directing slats in particular a shadow line of a slat longitudinal edge of an upper light-directing slat extends to a slat longitudinal edge of a lower light-directing slat on the shadow side, wherein the shadow line is at an angle αₛ with respect to the horizontal, wherein the angle as is at least approximately equal to the circle sector angle β, wherein the vertical distance D between the undersides of the upper and lower light-directing slats is equal to the width β multiplied by the tangent of the angle αₛ.

11. Sun protection device according to claim 10, characterized in that a radius r of curvature of the overall contour of the light-directing slat transversely with respect to the longitudinal direction is at least approximately equal to the width B of the light-directing slat divided by double the sine of half the circle sector angle β, preferably a ratio B/r being 0.5±0.05, with preference 0.51.

12. Sun protection device according to claim 10, characterized in that a preliminary material width b of a preliminary product of a light-directing slat that is curved transversely with respect to the longitudinal direction is equal to the radius r of curvature multiplied by the circle sector angle β in radians, with preference a ratio r/b being greater than 1.5 and less than 2.5, particularly preferably 1.9±0.2.

13. Method for producing a light-directing slat according to claim 5, wherein a preliminary product according to claim 1 is used, characterized in that the preliminary product is reshaped into a light-directing slat that is concave at the top side, wherein the angle γ is reduced by the reshaping process.

14. Method according to claim 13, characterized in that a planar preliminary product is embodied as wider on a strip-shaped preliminary product for slat production,
wherein the width of the strip-shaped preliminary material is defined transversely with respect to the longitudinal direction of the groove structure,
and the strip-shaped preliminary product with a width b of a light-directing slat is split from the starting material.

15. Method for producing a preliminary product according to claim 1, characterized in that the preliminary product is produced by its being provided with the groove structure by
a) the groove structure being embossed into the preliminary and subsequently being reflectively coated, in particular metallized, or
b) a transparent lamination film structured with the sidewalls F₁ and F₂ being applied to a carrier material,
wherein the sidewalls F₁ and F₂ are applied to the lamination film by a printing method, in particular in a rotary printing method,
wherein in particular a polymerizing printing varnish is applied,
wherein either the structure is deposited from a structured roller onto the film, or the structure is embossed into an applied printing varnish,
wherein the structured printing varnish is preferably cured, in particular by means of UV radiation, wherein the UV radiation impinges on the printing varnish preferably from the rear side through the film and cures said printing varnish, wherein afterwards the lamination film is metallized on the printed side.
